(19) United States
(12) Patent Application Publication
(10) Pub. No.: US 2023/0111451 A1
(43) Pub. Date: Apr. 13, 2023

(54) POWER EFFICIENT MANNER TO OPERATE USER EQUIPMENT (UE) IN MULTIPLE RADIO ACCESS TECHNOLOGY DUAL CONNECTIVITY

(71) Applicants: Punyaslok PURKAYASTHA, San Diego, CA (US); Ravi AGARWAL, San Diego, CA (US); Gavin Bernard HORN, San Diego, CA (US); Ozcan OZTURK, San Diego, CA (US); Peng CHENG, San Diego, CA (US); Huilin XU, San Diego, CA (US); QUALCOMM Incorporated, San Diego, CA (US)

(72) Inventors: Punyaslok PURKAYASTHA, San Diego, CA (US); Ravi AGARWAL, San Diego, CA (US); Gavin Bernard HORN, La Jolla, CA (US); Ozcan OZTURK, San Diego, CA (US); Peng CHENG, Beijing (CN); Huilin XU, Temecula, CA (US)

(21) Appl. No.: 17/801,901

(22) PCT Filed: Mar. 26, 2020
(86) PCT No.: PCT/CN2020/081438

§ 371 Date: Aug. 24, 2022

(51) Int. Cl. H04W 24/10; H04L 5/00; H04W 76/15

(52) U.S. Cl. CPC H04W 24/10; H04L 5/0051; H04W 76/15

(57) ABSTRACT

This disclosure provides systems, methods, apparatus, computer programs encoded on computer readable-medium to provide a user equipment (UE) to receive reference signals from a first base station, perform radio resource management (RRM) measurements based on the reference signals, and transmit information regarding the RRM measurements to a second base station. In another aspect, a UE receives reference signals from a first base station, performs channel quality indicator (CQI) measurements based on the reference signals, stores information regarding the CQI measurements, and transmitting the stored information to the first base station. In another aspect, a base station receives, from a UE, information associated with CQI measurements related to a second base station, and transmits the information to the second base station.

### TECHNICAL FIELD

The technology discussed below relates generally to wireless communication systems or networks, and more particularly, operating a user equipment (UE) in dormant or deactivated power efficient state with respect to a secondary base station or node (SN) in a dual connectivity configuration with a master base station or node (MN).

### DESCRIPTION OF THE RELATED TECHNOLOGY

In many existing wireless communication systems, a cellular network is implemented by enabling wireless user equipment to communicate with one another through signaling with one or more nearby base stations or cells. As a user equipment (UE) moves across the service area, handovers take place such that each UE maintains communication with one another via its respective base station and associated one or more cells. In a dual connectivity configuration, the UE may be connected to two or more base stations, each of the base stations may support a set of cells for providing radio resources for communicating with the UE.

### SUMMARY

The systems, methods and devices of this disclosure each have several innovative aspects, no single one of which is solely responsible for the desirable attributes disclosed herein.

One innovative aspect of the subject matter described in this disclosure relates to a method for wireless communication at an apparatus of a user equipment (UE), including receiving one or more reference signals from a first base station; performing one or more radio resource management (RRM) measurements based on the one or more reference signals; and transmitting information regarding the one or more RRM measurements to a second base station.

Another innovative aspect of the subject matter described in this disclosure can be implemented in a user equipment, including a wireless transceiver; and a processor configured to: receive one or more reference signals from a first base station via the wireless transceiver; perform one or more radio resource management (RRM) measurements based on the one or more reference signals; and transmit information regarding the one or more RRM measurements to a second base station via the wireless transceiver.

Another innovative aspect of the subject matter described in this disclosure can be implemented in an apparatus including means for receiving one or more reference signals from a first base station; means for performing one or more radio resource management (RRM) measurements based on the one or more reference signals; and means for transmitting information regarding the one or more RRM measurements to a second base station.

Another innovative aspect of the subject matter described in this disclosure relates to a non-transitory computer-readable medium storing computer-executable code, including code for causing a processor in a user equipment to: receive one or more reference signals from a first base station; perform one or more radio resource management (RRM) measurements based on the one or more reference signals; and transmit information regarding the one or more RRM measurements to a second base station.

Another innovative aspect of the subject matter described in this disclosure can be implemented in a wireless communication system including: a first base station; a second base station; and a user equipment configured to: receive one or more reference signals from the first base station; perform one or more radio resource management (RRM) measurements based on the one or more reference signals; and transmit information regarding the one or more RRM measurements to the second base station.

Another innovative aspect of the subject matter described in this disclosure relates to a method for wireless communication at an apparatus of a user equipment (UE), including receiving one or more reference signals from a first base station; performing one or more channel quality indicator (CQI) measurements based on the one or more reference signals; storing information regarding the one or more CQI measurements; and transmitting the stored information regarding the one or more CQI measurements to the first base station or a second base station.

Another innovative aspect of the subject matter described in this disclosure can be implemented in a user equipment, including a memory; a wireless transceiver; and a processor configured to: receive one or more reference signals from a first base station via the wireless transceiver; perform one or more channel quality indicator (CQI) measurements based on the one or more reference signals; storing information regarding the one or more CQI measurements in the memory; and transmit the stored information to the first base station or a second base station via the wireless transceiver.

Another innovative aspect of the subject matter described in this disclosure can be implemented in an apparatus including means for receiving one or more reference signals from a first base station; means for performing one or more channel quality indicator (CQI) measurements based on the one or more reference signals; means for storing information regarding the one or more CQI measurements; and means for transmitting the stored information regarding the one or more CQI measurements to the first base station or a second base station.

Another innovative aspect of the subject matter described in this disclosure relates to a non-transitory computer-readable medium storing computer-executable code, including code for causing a processor in a user equipment to: receive one or more reference signals from a first base station; perform one or more channel quality indicator (CQI) measurements based on the one or more reference signals; store information regarding the one or more CQI measurements; and transmit the stored information regarding the one or more CQI measurements to the first base station or a second base station.

Another innovative aspect of the subject matter described in this disclosure can be implemented in a wireless communication system including: a first base station; a second base station; and a user equipment configured to: receive one or more reference signals from a first base station; perform one or more channel quality indicator (CQI) measurements based on the one or more reference signals; store information regarding the one or more CQI measurements; and transmit the stored information regarding the one or more CQI measurements to the first base station or a second base station.

Another innovative aspect of the subject matter described in this disclosure relates to a method for wireless communication at an apparatus of a first base station, including receiving, from a user equipment (UE), information associated with one or more channel quality indicator (CQI) measurements related to a second base station; and transmitting the information to the second base station.

Another innovative aspect of the subject matter described in this disclosure can be implemented in a base station including: a wireless transceiver; a backhaul interface; and a processor configured to: receive, from a user equipment (UE) via the wireless transceiver, information associated with one or more channel quality indicator (CQI) measurements related to another base station; and transmit the information to the second base station via the backhaul interface.

Another innovative aspect of the subject matter described in this disclosure can be implemented in an apparatus including means for receiving, from a user equipment (UE), information associated with one or more channel quality indicator (CQI) measurements related to a second base station; and means for transmitting the information to the second base station.

Another innovative aspect of the subject matter described in this disclosure a non-transitory computer-readable medium storing computer-executable code, including code for causing a processor in a base station to: receive, from a user equipment (UE), information associated with one or more channel quality indicator (CQI) measurements related to a second base station; and transmit the information to the second base station.

Another innovative aspect of the subject matter described in this disclosure may be implemented in a wireless communication system, including: a user equipment; a first base station; a second base station configured to: receive, from the user equipment, information associated with one or more channel quality indicator (CQI) measurements related to first base station; and transmit the information to the first base station.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a diagram of an example wireless radio access network.

FIG. 2 shows a diagram of an example organization of wireless communication link resources in an air interface utilizing orthogonal frequency divisional multiplexing (OFDM).

FIG. 3 shows an example cellular communication system.

FIG. 4 shows an example flowchart of a method for a power efficient handover operation of the cellular communication system of FIG. 3.

FIG. 5 shows an example flowchart of a method for a power efficient link adaptation operation of the cellular communication system of FIG. 3.

FIG. 6 shows an example flowchart of a method for another power efficient link adaptation operation of the cellular communication system of FIG. 3.

FIG. 7 shows a block diagram of an example hardware implementation of a base station.

FIG. 8 shows an example flowchart of a method for reporting, by a master base station to a secondary base station, information regarding channel quality indicator (CQI) measurements performed by a user equipment (UE) based on reference signals received from the secondary base station for link adaptation purposes.

FIG. 9 shows a block diagram of an example hardware implementation of a user equipment (UE).

FIG. 10 shows an example flowchart of a method of reporting, by a user equipment (UE) to a master base station, radio resource management (RRM) measurements performed by the UE based on reference signals received from a secondary base station.

FIG. 11 shows an example flowchart of a method of reporting, by a user equipment (UE) to a master base station, radio resource management (RRM) measurements performed by the UE based on reference signals received from a secondary base station.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth^{®} standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA). Evolution Data Optimized (EV-DO). 1xEV-DO, EV-DO Rev A, EV-DO Rev B, High Speed Packet Access (HSPA). High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3 G. 4 G or 5 G, or further implementations thereof, technology.

In one aspect, a user equipment (UE) connected to a master base station or master node (MN) and a secondary base station or secondary node (SN) may operate in power efficient states associated with a secondary cell group (SCG) (which can include a primary cell (PScell) and one or more secondary cells (SScells)) of the SN. For example, in a deactivated state, the UE is not performing data transfer with the SN, not monitoring a physical downlink control channel (PDCCH) associated with the SN. and is not performing channel quality indicator (CQI) measurements with respect to the SN. In a dormant state, the UE is not performing data transfer with the SN, and not monitoring a physical downlink control channel (PDCCH) associated with the SN, but is performing channel quality indicator (CQI) measurements with respect to the SN. These states are low power consumption state as compared to an active state, where the UE is monitoring the PDCCH for data to be transmitted by the SN to the UE, and receiving data from the SN.

In another aspect, the UE operates in a manner to ensure coverage by the SN in the deactivated or dormant state. In this regard, the UE performs radio resource management (RRM) measurements associated with the SCG or SN while in the dormant or deactivated states, and reports these measurements to the MN. The RRM measurements are used by the MN to determine if a handover is to be effectuated with respect to the SN or the PSCell of the SCG. Thus, a purpose of the RRM measurements is to ensure continued coverage by the SN. If the RRM measurements indicate that coverage is being lost, the MN on the basis of the RRM measurements can command the UE to perform PSCell change or SN change.

In still another aspect, the UE operates in a manner to reduce the delay between transitioning from the dormant state to the active state. In this regard, the UE performs channel quality indicator (CQI) measurements with respect to the SCG or SN while in the dormant state, and stores the measurements for subsequent reporting to the SN (directly or via the MN) when the UE transitions to the active state. The CQI measurements are used by the SN to perform link adaptation (such as selecting the modulation coding scheme (MCS)) for the data radio bearer (DRB) to the UE. Thus, when the UE enters the active state, the delay may be relatively small since the SN has already the link adaptation information.

Particular implementations of the subject matter described in this disclosure can be implemented to realize one or more of the following potential advantages. For example, when the UE is not receiving data from an SN or transmitting data to the SN, the UE may be able to operate in a deactivated or dormant state where it is not consuming power in monitoring a physical downlink control channel (PDDCH) for data transmitted by the SN, thus saving power. Additionally, in the deactivated or dormant state, by having the UE report RRM measurements concerning the SN to the MN, coverage can be ensured by the SN when data is to be transmitted by the SN to the UE. Moreover, in the dormant state, the UE may report CQI measurements to the SN directly or via the MN so that the SN may perform link adaptation (such as select the modulation coding scheme (MCS)) when data is to be transmitted to the UE upon transitioning from the dormant state to the active state; thereby reducing the delay in the UE receiving the data.

The various concepts presented throughout this disclosure may be implemented across a broad variety of telecommunication systems, network architectures, and communication standards.

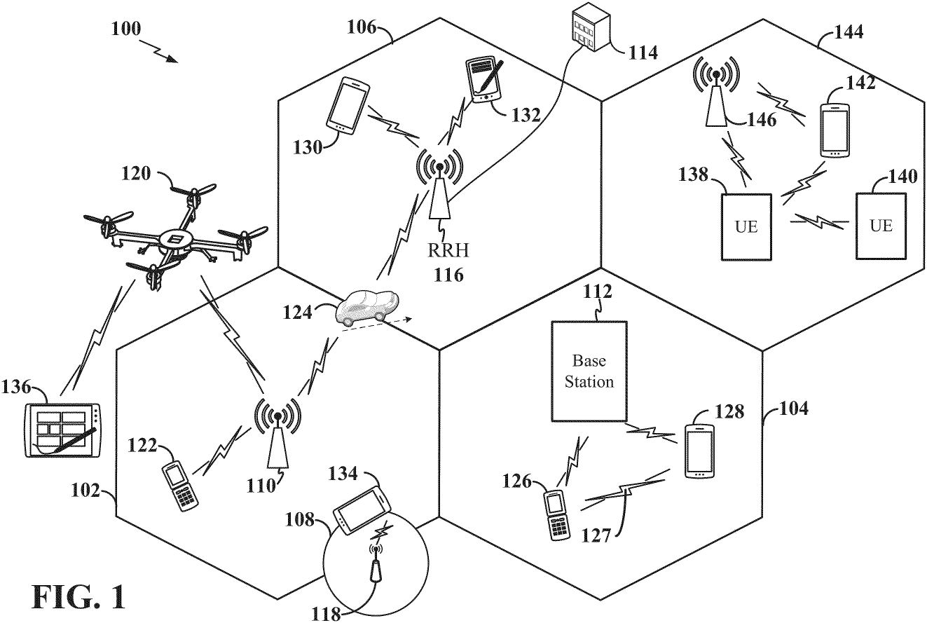

FIG. 1 shows a diagram of an example wireless radio access network 100 (e.g.. a wireless communication system). The RAN 100 may implement any suitable wireless communication technology or technologies to provide radio access. As one example, the RAN 100 may operate according to 3^{rd} Generation Partnership Project (3 GPP) New Radio (NR) specifications, often referred to as 5 G. As another example, the RAN 100 may operate under a hybrid of 5 G NR and Evolved Universal Terrestrial Radio Access Network (eUTRAN) standards, often referred to as LTE. The 3 GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates macrocells 102, 104, and 106, and a small cell 108, each of which may include one or more sectors (not shown). A sector is a sub-area of a cell. All sectors within one cell are served by the same base station. A radio or communication link within a sector can be identified by a single logical identification belonging to that sector. In a cell that is divided into sectors, the multiple sectors within a cell can be formed by groups of antennas, with each antenna responsible for communication with UEs in a portion of the cell.

In general, a respective base station (BS) serves each cell. Broadly, a base station is a network element in a radio access network responsible for radio transmission and reception in one or more cells to or from a UE. A BS also may be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB) or some other suitable terminology.

In FIG. 1, two base stations 110 and 112 are shown in cells 102 and 104. respectively; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the small cell 108 (such as a microcell, picocell, femtocell, home base station, home Node B, home eNode B, etc.), which may overlap with one or more macrocells. In this example, the cell 108 may be referred to as a small cell, as the base station 118 supports a cell having a relatively small size. Cell sizing can be done according to system design as well as component constraints. It is to be understood that the radio access network 100 may include any number of wireless base stations and cells. Further, a relay node or UE may be deployed to extend the size or coverage area of a given cell, as well as provide diversity or aggregated communication links between a base station and a UE. The base stations 110, 112, 114, and 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion (not shown) of the network. The backhaul may provide a link between a base station and a core network (not shown); and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as a user equipment (UE) in standards and specifications promulgated by the 3rd Generation Partnership Project (3 GPP), but also may be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some nonlimiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, such as corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer or wearable device, such as eyewear, a wearable camera, a virtual reality device, a smart watch, a health or fitness tracker, a digital audio player (such as MP3 player), a camera, a game console, etc.

A mobile apparatus may additionally be a digital home or smart home device such as a home audio, video, or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (such as a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, such as in terms of prioritized access for transport of critical service data, or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In another example, a mobile network node (such as quadcopter 120) may be configured to function as a UE. For example, the quadcopter 120 may operate within cell 102 by communicating with base station 110.

Wireless communication between a RAN 100 and a UE (such as UE 122 or 124) may be described as utilizing an air interface. Transmissions over the air interface from a base station (such as base station 110) to one or more UEs (such as UE 122 and 124) may be referred to as downlink (DL) transmission. In accordance with certain aspects of the present disclosure, the term downlink may refer to a point-to-multipoint transmission originating at a scheduling entity (described further below; such as base station 110). Another way to describe this scheme may be to use the term broadcast channel multiplexing. Transmissions from a UE (such as UE 122) to a base station (such as base station 110) may be referred to as uplink (UL) transmission. In accordance with further aspects of the present disclosure, the term uplink may refer to a point-to-point transmission originating at a scheduled entity (described further below; such as UE 122).

For example, DL transmissions may include unicast or broadcast transmissions of control information or traffic information (such as user data traffic) from a base station (such as base station 110) to one or more UEs (such as UEs 122 and 124), while UL transmissions may include transmissions of control information or traffic information originating at a UE (such as UE 122). In addition, the uplink or downlink control information or traffic information may be time-divided into frames, subframes, slots, or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1ms. Multiple subframes or slots may be grouped together to form a single frame or radio frame. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5 G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, such as several times per slot.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In various aspects of the disclosure, a RAN 100 may utilize DL-based mobility or UL-based mobility to enable mobility and handovers (i.e., the transfer of a UE’s connection from one radio channel to another). In a network configured for DL-based mobility, during a call with a scheduling entity, or at any other time, a UE may monitor various parameters of the signal from its serving cell as well as various parameters of neighboring cells.

Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In a network configured for UL-based mobility, UL reference signals from each UE may be utilized by the network to select a serving cell for each UE. In some examples, the base stations 110, 112, and 114/116 may broadcast unified synchronization signals (such as unified Primary Synchronization Signals (PSSs), unified Secondary Synchronization Signals (SSSs) and unified Physical Broadcast Channels (PBCH)). The UEs 122, 124, 126, 128, 130, and 132 may receive the unified synchronization signals, derive the carrier frequency and radio frame timing from the synchronization signals, and in response to deriving timing, transmit an uplink pilot or reference signal. The uplink pilot signal transmitted by a UE (such as UE 124) may be concurrently received by two or more cells (such as base stations 110 and 114/116) within the RAN 100. Each of the cells may measure a strength of the pilot signal, and the RAN (such as one or more of the base stations 110 and 114/116 or a central node within the core network) may determine a serving cell for the UE 124. As the UE 124 moves through the RAN 100, the network may continue to monitor the uplink pilot signal transmitted by the UE 124. When the signal strength or quality of the pilot signal measured by a neighboring cell exceeds that of the signal strength or quality measured by the serving cell, the RAN 100 may handover the UE 124 from the serving cell to the neighboring cell, with or without informing the UE 124.

Although the synchronization signal transmitted by the base stations 110, 112, and 114/116 may be unified, the synchronization signal may not identify a particular cell, but rather may identify a zone of multiple cells operating on the same frequency or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum; the technical rules or limitations may be required to access the spectrum, but the spectrum may still be shared by multiple operators or multiple radio access technologies (RATs). For example, the holder of a license for a portion of licensed spectrum may provide licensed shared access (LSA) to share that spectrum with other parties, such as with suitable licensee-determined conditions to gain access.

In some examples, access to the air interface may be scheduled, a scheduling entity (such as a base station) allocates resources (such as time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (such as one or more other UEs). In this example, sidelink or other type of direct link signals may be communicated directly between UEs without relying on scheduling or control information from another entity, such as a base station. For example, UE 138 is illustrated communicating with UEs 140 and 142. In some examples, the UE 138 is functioning as a scheduling entity, while UEs 140 and 142 may function as scheduled entities. For example, UE 138 may function as a scheduling entity in a device-to-device (D2D), peer-to-peer (P2P), vehicle-to-everything (V2X), or in a mesh network. In a mesh network example, UEs 140 and 142 may optionally communicate directly with one another in addition to communicating with the scheduling entity 138.

In some other examples, two or more UEs (such as UEs 126 and 128) within the coverage area of a serving base station 112 may communicate with both the base station 112 using cellular signals and with each other using direct link (such as sidelink) signals 127 without relaying that communication through the base station. In an example of a V2X network within the coverage area of the base station 112, the base station 112 or one or both of the UEs 126 and 128 may function as scheduling entities to schedule sidelink communication between UEs 126 and 128.

The sidelink communication 127 between UEs 126 and 128 or between UEs 138, 140, and 142 may occur over a proximity service (ProSe) PC5 interface. ProSe communication may support different operational scenarios, such as in-coverage, out-of-coverage, and partial coverage. Out-of-coverage refers to a scenario in which UEs (such as UEs 138, 140 and 142) are outside the coverage are of a base station (such as base station 146), but each are still configured for ProSe communication. Partial coverage refers to a scenario in which a UE is outside the coverage area of a base station, while one or more other UEs in communication with the UE are in the coverage area of a base station. In-coverage refers to a scenario in which UEs (such as UEs 126 and 128) are in communication with a base station (such as base station 112) via a Uu (such as a cellular interface) connection to receive ProSe service authorization and provisioning information to support ProSe operation.

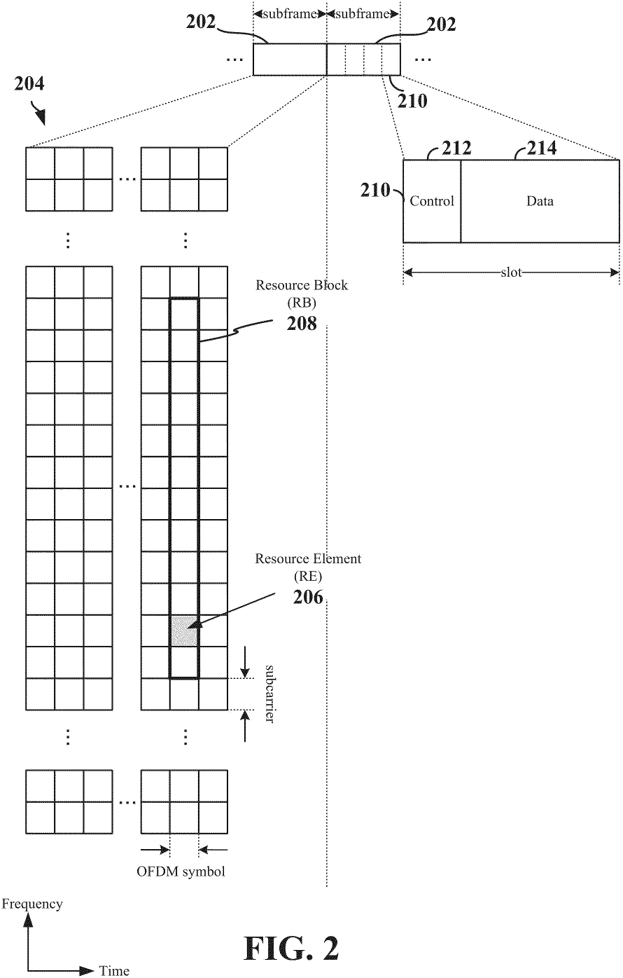

Various aspects of the present disclosure will be described with reference to an OFDM waveform, schematically illustrated in FIG. 2. It may be understood by those of ordinary skill in the art that the various aspects of the present disclosure may be applied to an SC-FDMA waveform in substantially the same way as described herein below. That is, while some examples of the present disclosure may focus on an OFDM link for clarity, it may be understood that the same principles may be applied as well to SC-FDMA waveforms.

FIG. 2 shows a diagram of an example organization of wireless communication link resources in an air interface utilizing orthogonal frequency divisional multiplexing (OFDM). An expanded view of an example subframe 202 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier × 1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 208 entirely corresponds to a single direction of communication (either transmission or reception for a given device).

Scheduling of UEs devices for downlink, uplink, or sidelink transmissions typically involves scheduling one or more resource elements 206 within one or more sub-bands. Thus, a UE device generally utilizes only a subset of the resource grid 204. In some examples, an RB may be the smallest unit of resources that can be allocated to a UE device. Thus, the more RBs scheduled for a UE device, and the higher the modulation scheme chosen for the air interface, the higher the data rate for the UE device. The RBs may be scheduled by a base station (such as gNB, eNB, RSU, etc.) or may be self-scheduled by a UE implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 millisecond (ms) subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (such as one to three OFDM symbols). These mini-slots may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The simple structure illustrated in FIG. 2 is merely example in nature, and different slot structures may be utilized, and may include one or more of each of the control region(s) and data region(s).

Although not illustrated in FIG. 2, the various REs 206 within an RB 208 may be scheduled to cany one or more physical channels, including control channels, shared channels, data channels, etc. Other REs 206 within the RB 208 also may carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control or data channels within the RB 208.

In some examples, the slot 210 may be utilized for broadcast or unicast communication. In V2X or D2D networks, a broadcast communication may refer to a point-to-multipoint transmission by a one device (such as a vehicle, base station (such as RSU, gNB, eNB, etc.), UE, or other similar device) to other devices. A unicast communication may refer to a point-to-point transmission by a one device to a single other device.

In an example of cellular communication over a cellular carrier via a Uu interface, for a DL transmission, the scheduling entity (such as a base station) may allocate one or more Res 206 (such as within the control region 212 of the slot 210) to carry DL control information including one or more DL control channels, such as an SSB, PDCCH, etc. to one or more scheduled entities (such as UEs), which may include one or more sidelink devices (such as V2X/D2D devices). The PDCCH carries downlink control information (DCI) including, for example, scheduling information that provides a grant, or an assignment of REs for DL and UL transmissions.

In an UL transmission over the Uu interface, the scheduled entity may utilize one or more REs 206 to carry UL control information (UCI) including one or more UL control channels, such as a physical uplink control channel (PUCCH), to the scheduling entity. UCI may include, for example, pilots, reference signal, and information to enable or assist in decoding uplink data transmissions. In some examples, the UCI may include a scheduling request (SR), i.e., request for the scheduling entity to schedule uplink transmissions.

In addition to control information, one or more REs 206 (such as within the data region 214) may be allocated for user data traffic. Such traffic may be carried on one or more traffic channels, such as, for a DL transmission, a physical downlink shared channel (PDSCH); or for an UL transmission, a physical uplink shared channel (PUSCH). In some examples, one or more REs 206 may be configured to carry system information blocks (SIBs), carrying information that may enable access to a given cell.

In an example of sidelink communication over a sidelink carrier via a PC5 interface, the control region 212 of the slot may include control information transmitted by sidelink devices over the sidelink channel, while the data region 214 of the slot 210 may include data transmitted by sidelink devices over the sidelink channel. In some examples, the control information may be transmitted within sidelink control information (SCI) over a physical sidelink control channel (PSCCH), while the data may be transmitted within a physical sidelink shared channel (PSSCH). For in-coverage or partial-coverage scenarios, the DCI transmitted by the base station over the Uu interface may include scheduling information indicating one or more resource blocks within the control region 212 or data region 214 allocated to sidelink devices for sidelink communication.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

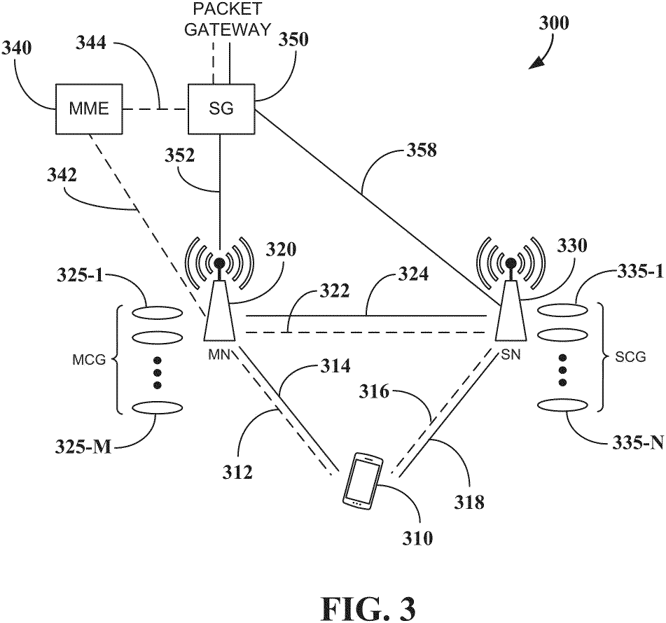

FIG. 3 shows an example cellular communication system 300. As discussed in more detail herein, a user equipment (UE) has simultaneous connections (signaling and data radio bearers) to both a master base station (also referred to as a “master node (MN)”) and a secondary base station (also referred to as a “secondary master node (SN)”) in a multiple radio access technology (RAT) dual connectivity configuration.

Dual connectivity offers many advantages, such as increased data rates due to the UE using radio resources from both the master and secondary base stations; increased reliability as the secondary base station provides another data pipeline that can be used to transmit data between a cellular network core and the UE; improved load balancing between different base stations of a cellular communication system; improved deployment of NR base stations and infrastructure using an existing LTE cellular communication system; and reusing LTE cellular communication infrastructure to implement NR base stations and other infrastructure.

As discussed herein, a UE may operate in a power efficient manner with respect to the secondary base station especially when data is not being communicated between the secondary base station and the UE. For example, the UE may be in a “deactivated” operating state associated with the SCG of a secondary base station characterized by: (1) no data transfer occurring between the secondary base station and the UE; (2) the UE does not monitor the physical downlink control channel (PDCCH) signal transmitted by the secondary base station; and (3) the UE is not performing channel quality indicator (CQI) measurements of the channels between the secondary base station and the UE. By not performing data transfer, monitoring of the PDCCH signal, and performing CQI measurements, the UE saves substantial power, such that the UE operates in a power efficient manner.

In another example, the UE may be in a “dormant” operating state associated with the SCG of a secondary base station characterized by: (1) no data transfer occurring between the secondary base station and the UE; (2) the UE does not monitor the physical downlink control channel (PDCCH) signal transmitted by the secondary base station; and (3) the UE is performing CQI measurements based on reference signals received from the secondary base station. Although, in the dormant operating state, the UE is consuming more power than if it were in the deactivated operating state (due to the CQI measurements), the UE is still being operated in a power efficient manner as it does not monitor the PDCCH signal and may not maintain uplink (UL) timing with the secondary base station.

When data is to be transferred between the secondary base station and the UE, the UE transitions from either the deactivated or dormant state to an “active” operating state associated with the SCG of a secondary base station. In an active state, the UE monitors the PDCCH signal to determine whether there is data being sent from the secondary base station to the UE, in which one or more resource blocks (RBs) the data resides, and the link adaptation information, such as the modulation and coding scheme (MCS) used to send the data; and also maintains UL link timing in case some type of automatic repeat request (ARQ) messages are used. Because of the additional tasks the UE needs to do in the active operating state, the UE is consuming more power in the active state than it does in the deactivated or dormant state. Thus, if no data is being communicated between the secondary base station and the UE, the UE may operate in either deactivated or dormant state to conserve power. With regard to the master base station, the UE operates in the active state to prevent delay between the exchange of data and signaling between the UE and the cellular core network via the master base station.

In addition to the aforementioned operating states (deactivated, dormant, and active states) with respect to the secondary base station, the UE performs an operation to ensure coverage by the SN in the deactivated or dormant state. One operation is to perform one or more radio resource management (RRM) measurements based on one or more reference signals received from the secondary base station while the UE is in the deactivated or dormant state.

RRM measurements may include one or more of the following: reference signal received power (RSRP) measurements, reference signal received quality (RSRQ) measurements, carrier received signal strength indicator (RSSI), and signal to interference noise radio (SINR). If the secondary base station supports a set of cells (also referred to a secondary cell group (SCG), the UE may perform RRM measurements based on reference signals generated by the cells of the SCG, respectively. The UE also may perform RRM measurements based on reference signals generated by candidate secondary base stations. As an example, from each secondary base station or cells in an SCG supported by base stations, the reference signals may be channel state information reference signals (CSI-RS) or signal synchronization block (SSB) signals. The RRM measurements are used to make handover decisions with regard to the secondary base station, such as changing the secondary base station assigned to the UE or changing the primary secondary cell (PSCell) of the SCG. The PSCell is the cell to which the UE performs an attachment or reattachment process. The other cells in the SCG may be used in conjunction with the PSCell for carrier aggregation (CA) to increase data rates between the secondary base station and the UE.

Further, in accordance with the RRM measurement operations while the UE is in the deactivated or dormant operating states, the UE transmits information regarding the RRM measurements to the master base station. The master base station may use this information to determine whether a change or handoff is needed with regard to the secondary base station assigned to the UE or the PSCell assigned to the UE. If such change or handover is needed, the master base station generates the appropriate signaling to initiate the change or handover. Thus, when the operating state of the UE transitions from deactivated or dormant state to active state, the appropriate secondary base station and PSCell is used for transferring data between the secondary base station and the UE.

Another operation the UE performs is for reducing the delay in transitioning from the dormant state to the active state in a power efficient manner is to store or buffer CQI measurements based on reference signals received from the secondary base station, and transmit the CQI measurements to the secondary base station upon entering the active state. CQI measurements, which are indications of signal to interference plus noise radio (SINR), may be based on the CSI-RS reference signals transmitted by the secondary base station or the cells of the SCG of the secondary base station. The CQI measurements are useful in link adaptation (such as selecting the appropriate MCS based on channel conditions as indicated by the CQI measurements) when data is to be transferred between the second base station and the UE. Thus, when the UE enters the active state and transmits information regarding the CQI measurements to the secondary base station, the secondary base station is able to quickly perform link adaptation for transmitting data to the UE.

Another operation the master base station performs to reduce the delay between a UE transitioning from the dormant operating state to active operating state is for the master base station to forward information, regarding CQI measurements performed by the UE with respect to the secondary base station when the UE is in the dormant state, to the secondary base station via a signaling link. The secondary base station having this information handy when the UE enters the active state allows the secondary base station to quickly perform link adaptation (such as selecting the MCS for the data) and transmit data to the UE based on the link adaptation. The aforementioned operating states and process to reduce delay between the UE operating in the deactivated state or dormant state and changing to the active state is discussed in more detail below with reference to the cellular or wireless communication system 300 shown in FIG. 3.

The cellular communication system 300 includes a user equipment (UE) 310, a master base station or MN 320, and secondary base station or SN 330. The master base station 320 may support a set of cells 325-1 to 325-M (where M may be one or more), often referred to as a master cell group (MCG). The cells of the MCG 325-1 to 325-M may transmit and receiving data and signaling to and from the UE 310 using distinct radio frequency (RF) carriers, such as in the case of carrier aggregation (CA). Similarly, the secondary base station 330 may support a set of cells 335-1 to 325-N (where N may be one or more), often referred to as a secondary cell group (SCG). The cells of the SCG 335-1 to 335-N may transmit and receiving data and signaling to and from the UE 310 using distinct radio frequency (RF) carriers, such as in the case of carrier aggregation (CA).

The cellular communication system 300 further includes a mobility management equipment (MME) 340 and a serving gateway (SG) 350. Although the MME 340 performs numerous functions, the MME 340 is responsible for tracking the locations, paging and authentication of UEs. The SG 350 is responsible for forwarding data packets between a packet gateway, which connects to the Internet or other networks, and base stations. Although not shown, the cellular communication system 300 may include additional infrastructure, such as a packet gateway, home subscriber server (HSS), billing servers, etc.

There are various control plane and user plane links between various network components of the cellular communication system 300. As illustrated in FIG. 3, control plane links are shown as dashed line between network components, and the user plane links are shown as solid lines between components. The control plane link is for sending control signals or signaling. The user plane link is for sending data from or to UEs via one or more network components. For example, the cellular communication system 300 includes a control plane link 342 (such as S1-MME) between the MME 340 and the master base station 320; a control plane link 344 (such as S11) between the MME 340 and the SG 350; a control plane link 322 (such as Xn/X2) and user plane link 324 (X2-U) between the master base station 320 and the secondary base station 330; a user plane link 352 (such as S1-U) between the SG 350 and the master base station 320; and may include a user plane link 358 (such as S1-U) between the SG 350 and the secondary base station 330, although in some implementations the secondary base station receives user data via the user plane link 324.

In this example, the UE 310 is connected to the master base station 320 via signaling radio bearer (SRB) 312 and data radio bearer (DRB) 314. The SRB 312 is used for transmitting control signals from the master base station 320 to the UE 310 via downlink (DL) transmissions, and transmitting control signals from the UE 310 to the master base station 320 via uplink (UL) transmissions. Similarly, the UE 310 is connected to the secondary base station 330 via signaling radio bearer (SRB) 316 and data radio bearer (DRB) 318. The SRB 316 is used for transmitting control signals from the secondary base station 330 to the UE 310 via downlink (DL) transmissions, and transmitting control signals from the UE 310 to the secondary base station 330 via uplink (UL) transmissions.

Because the UE 310 is connected to two base stations 320 and 330. it is said that the UE is in a multi-rat dual connectivity configuration. As previously discussed, there are several advantages of the dual connectivity configuration including higher data rates, increased reliability, load balancing, NR launching over existing LTE network, etc. As indicated by the last stated advantage, the cellular communication system 300 may include a mixture of LTE and NR infrastructure. For example, in the case of EUTRA-NR (EN-DC) Dual Connectivity, the master base station 320 may be an LTE base station (such as a master eNB (MeNB)) and the secondary base station may be an NR base station (such as En-gNB). In some other implementations, the master base station 320 may be an NR base station, and the secondary base station 330 may be an LTE base station. In still other implementations, the master base station 320 and secondary base station 330 may be of the same type, both LTE base stations or both NR base stations.

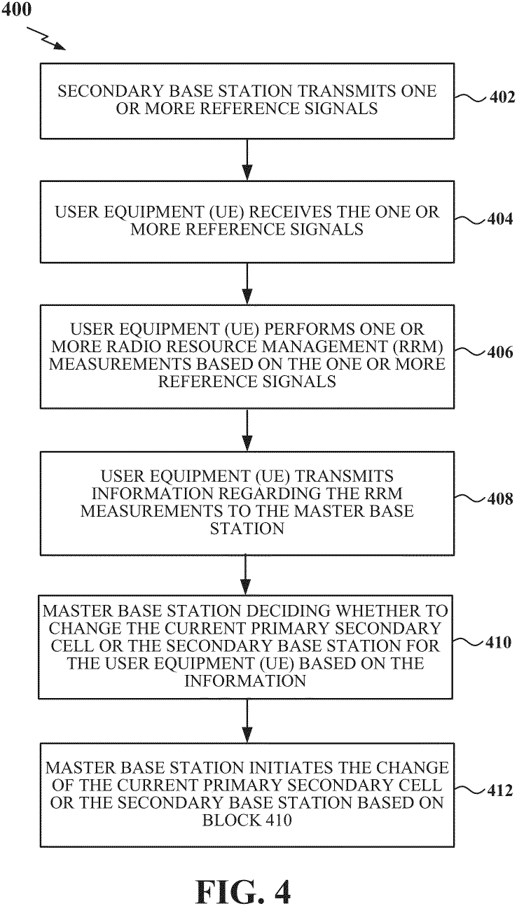

FIG. 4 shows an example flowchart of a method 400 for a power efficient handover operation of the cellular communication system of FIG. 3. The method 400 is described with reference to the cellular communication system 300 previously described. With regard to the method 400, the UE 310 is in the deactivated or dormant operating state. That is, in both these states, the UE 310 is not receiving data from the secondary base station 330 and is not monitoring any PDCCH signal transmitted by the secondary base station 330.

In the deactivated state, the UE 310 is not performing CQI measurements based on reference signals transmitted by the secondary base station 330. In the dormant state, the UE 310 is performing CQI measurements based on reference signals transmitted by the secondary base station 330, and may report the CQI measurements to the secondary base station 330 (optionally via the master base station 320) upon entering the active state, or may report the CQI measurements to the master base station 320 while the UE 310 is operating in the dormant state. While operating in the deactivated or dormant state, the UE 310 consumes less power if it were otherwise operating in the active state. Further, as discussed, the UE 310 may be in a dual connectivity configuration where the UE is connected to the master base station 320 and to the secondary base station 330.

The method 400 includes the secondary base station 330 transmitting one or more reference signals (block 402). In some implementations, the one or more reference signals may each be a CSI-RS, an SSB, or other. In some implementations, if the secondary base station 330 supports an SCG, the set of cells 335-1 to 335-N in the SCG transmit reference signals, respectively.

The method 400 further includes the UE 310 receiving the one or more reference signals (block 404), and performing one or more RRM measurements based on the one or more reference signals (block 406). In some implementations, the one or more RRM measurements are based on a configuration for RRM measurements received from the secondary base station 330. In some implementations, each RRM measurement may include a measurement of one or more of the following: RSRP, RSRQ, RSSI, and SINR. In another implementations, if the secondary base station 330 includes the set of cells 335-1 to 335-N in the SCG: in block 404, the UE 310 receives a set of the reference signals from the set of cells 335-1 to 335-N. respectively; and in block 406, and the UE 310 performs a set of the RRM measurements based on the set of reference signals, respectively.

The method 400 further includes the UE 310 transmitting information regarding the one or more RRMs to the master base station 320 (block 408). In some implementations, the UE 310 transmits the information to the master base station 320 via a signaling radio bearer (SRB). In another implementation, the UE 310 transmits the information to the master base station 320 via SRB1 as defined in the LTE or NR specifications. In yet another implementation, the UE 310 transmits the information to the master base station 320 via a first SRB while a second SRB exists for transmitting signaling from the UE 310 to the secondary base station 330. In still another implementation, the UE 310 transmits the information to the master base station 320 via SRB1 while SRB3 exists for transmitting signaling from the UE 310 to the secondary base station 330, the SRB1 and SRB3 being defined in LTE or NR specifications. In another implementation, if the secondary base station 330 includes the set of cells 335-1 to 335-N in the SCG. the UE 310 transmits information regarding the set of RRM measurements to the master base station 320.

The method 400 may further include the master base station 320 deciding whether to change (handover) the current primary secondary cell (PSCell) or the secondary base station assigned to the UE based on the RRM measurement information received form the UE (block 410). If the master base station 320 decides the perform the change per block 410, the master base station 320 initiates the change of the PSCell or secondary base station (block 412). In some implementations, this may entail the master base station 320 providing signaling to the secondary base station 330 via control link 322, the MME 340 via control link 342, and the new secondary base station via another control link (not shown).

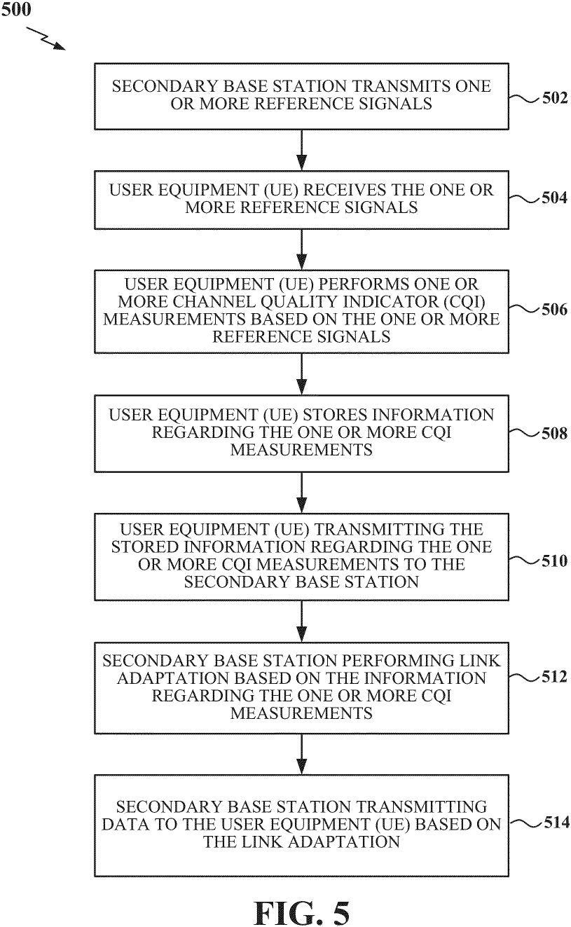

FIG. 5 shows an example flowchart of a method 500 for a power efficient link adaptation operation of the cellular communication system of FIG. 3. The method 500 is described with reference to the cellular communication system 300 previously described. With regard to the method 500, the UE 310 is in the dormant operating state. That is, the UE 310 is not receiving data from the secondary base station 330, is not monitoring the PDCCH signal transmitted by the secondary base station 330, and is performing CQI measurements based on reference signals transmitted by the secondary base station 330. While operating in the dormant state, the UE 310 consumes less power if it were otherwise operating in the active state. Further, as discussed, the UE 310 may be in a dual connectivity configuration where the UE is connected to the master base station 320 and to the secondary base station 330.

The method 500 includes the secondary base station 330 transmitting one or more reference signals (block 502). In some implementations, the one or more reference signals may each be a CSI-RS, an SSB, or other. In another implementation, if the secondary base station 330 supports an SCG, the set of cells 335-1 to 335-N in the SCG transmit reference signals, respectively.

The method 500 further includes the UE 310 receiving the one or more reference signals (block 504), and performing one or more CQI measurements based on the one or more reference signals (block 506). In some implementations, the one or more CQI measurements are based on a configuration for CQI measurements received from the secondary base station 330. In some implementations, each CQI measurement may be based on an SINR measurement. In another implementation, if the secondary base station 330 includes the set of cells 335-1 to 335-N in the SCG: in block 504, the UE 310 receives a set of the reference signals from the set of cells 335-1 to 335-N, respectively; and in block 506, and the UE 310 performs a set of the CQI measurements based on the set of reference signals, respectively.

The method 500 further includes the UE 310 storing or buffering information regarding the one or more CQIs in an internal memory (block 508). In one implementation, the UE 310 may store the information based on a parameter. For example, in one implementation, the parameter may specify a number of most recent CQI measurements to be stored or included for subsequent transmission to the secondary base station 330. In another implementation, the parameter may specify the most recent CQI measurements taken within a defined time interval to be stored or included for subsequent transmission to the secondary base station 330.

The method 500 further includes the UE 310 transmitting information regarding the one or more CQI measurements to the secondary base station 330 (block 510). In some implementations, if the UE 310 determines that it is not uplink (UL) timing aligned with the secondary base station 330 upon transitioning from the dormant to the active state, the UE 310 performs a random access channel (RACH) process with the secondary base station 330 to reacquire UL timing. In another implementation, the UE 310 transmits the stored information to the secondary base station 330 after transitioning to the active state and the completion of the RACH process. In another implementation, the UE transmits the information regarding the CQI measurements to the master base station 320 for subsequent forwarding to the secondary base station 330. As discussed, in another implementation, only the most recent CQI measurements based on the parameter discussed above are transmitted to the secondary base station 330. In another implementation, in the case the set of CQI measurements were based on reference signals transmitted by the set of cells 335-1 to 335-N of the SCG, the UE 310 transmits the set of CQI measurements to the secondary base station 330.

In some implementations, the UE 310 transmits the information to the secondary base station 330 in response to the UE 310 receiving a signal from the master base station 320 to operate in the active state. In another implementation, the UE 310 monitors the PDCCH channel for data transmitted by the secondary base station 330 when the UE 310 is operating in the active state. In yet another implementation, the UE 310 receives data from the secondary base station 330 via the PDSCH in the active state.

The method 500 may further include the secondary base station 330 performing link adaptation for transmitting data to the UE 310 based on the one or more CQI measurements (block 512). In some implementations, the secondary base station 330 performs the link adaptation by selecting a modulation coding scheme (MCS) based on the one or more CQI measurements. The method 500 further includes the secondary base station 330 transmitting the data to the UE 310 based on the link adaptation (block 514).

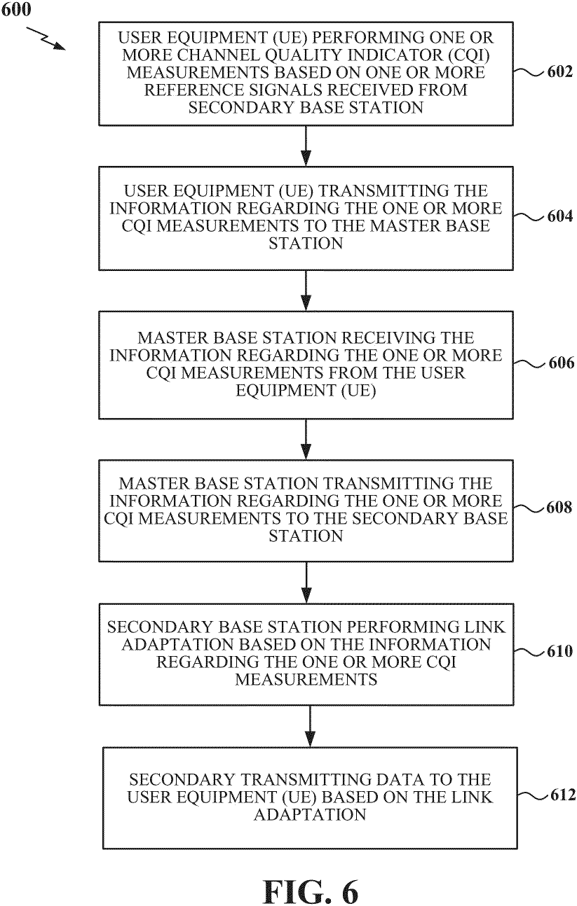

FIG. 6 shows an example flowchart of a method for another power efficient link adaptation operation of the cellular communication system of FIG. 3. The method 600 is described with reference to the cellular communication system 300 previously described. In this example, the master base station 320 and secondary base station 330 may be in a dual connectivity configuration with the UE 310.

The method 600 includes the UE 310 performing one or more CQI measurements based on the one or more reference signals received from the secondary base station 330 (block 602). In some implementations, the UE is operating in the dormant state while performing the operation specified in block 602. In some implementations, each CQI measurement may be based on an SINR measurement. In another implementation, if the secondary base station 330 includes the set of cells 335-1 to 335-N in the SCG: the UE 310 performs a set of CQI measurements based on a set of the reference signals received from the set of cells 335-1 to 335-N, respectively.

The method 600 further includes the UE 310 transmitting information regarding the one or more CQI measurements to the master base station 320 (block 604). In some implementations, the UE 310 is in a dormant state associated with the SCG of the secondary base station 330. In another implementation, the UE 310 transmits the information via a signaling radio bearer (SRB). In another implementation, the UE 310 transmits the information via SRB1 as defined by LTE or NR specifications. In yet another implementation, the UE 310 transmits the information via a PUCCH channel. In still another implementation, the UE 310 transmits the information via a PUSCH channel. In another implementation, if the UE 310 receives a set of reference signals from the set of cells 335-1 to 335-N of the SCG, the UE 310 transmits information regarding the set of CQI measurements to the master base station 320.

The method 600 further includes the master base station 320 receiving the information regarding the one or more CQI measurements from the UE 310 (block 606). Again, in different implementations, the master base station 320 may receiving information regarding the one or more CQI measurements via an SRB, SRB1, PUCCH, or PUSCH. In yet another implementation, the master base station 320 may receive a set of CQI measurements associated with the set of cells 335-1 to 335-N of the SCG of the secondary base station 330.

The method 600 further includes the master base station 320 transmitting the information regarding the one or more CQI measurements to the secondary base station 330 (block 608). In some implementations, the master base station 320 transmits the information to the secondary base station 330 via control link or a backhaul communication link, such as signaling link 322 (such as Xn/X2 type link). In another implementation, the master base station 320 transmits a set of CQI measurements associated with the set of cells 335-1 to 335-N in the SCG to the secondary base station 330.

The method 600 may further include the secondary base station 330 performing link adaptation for transmitting data to the UE 310 based on the one or more CQI measurements (block 610). In some implementations, the secondary base station 330 performs the link adaptation by selecting a modulation coding scheme (MCS) based on the one or more CQI measurements. The method 600 further includes the secondary base station 330 transmitting the data to the UE 310 based on the link adaptation (block 612).

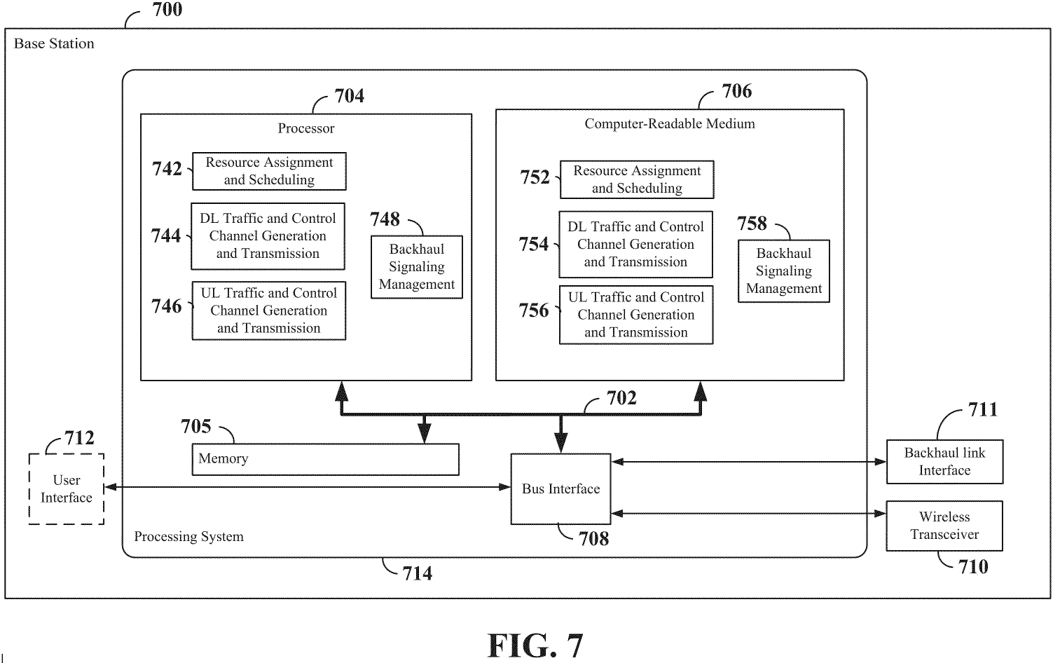

FIG. 7 shows a block diagram of an example hardware implementation of a base station 700. The base station 700 is depicted employing a processing system 714. For example, the base station 700 may correspond to any of the base stations previously discussed herein, such as the master base station 320 and the secondary base station 330.

The base station 700 may be implemented with a processing system 714 that includes one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the base station device 700 may be configured to perform any one or more of the functions described herein. That is, the processor 704. as utilized in the base station 700, may be used to implement any one or more of the processes and procedures described below.

In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors (represented generally by the processor 704), a memory 705, and computer-readable media (represented generally by the computer-readable medium 706). The bus 702 also may link various other circuits such as timing sources, peripherals, voltage regulators, and power management circuits.

A bus interface 708 provides an interface between the bus 702 and a wireless transceiver 710 and a backhaul link interface 711. The wireless transceiver 710 allows for the base station 700 to communicate with various other apparatus over a transmission medium (such as air interface). The backhaul link interface 711 allows for the base station 700 to communicate with various other apparatus over a backhaul communication link (such as a wired interface). Depending upon the nature of the apparatus, a user interface 712 (such as keypad, display, touch screen, speaker, microphone, control knobs, etc.) also may be provided. Of course, such a user interface 712 is optional, and may be omitted in some examples.

The processor 704 is responsible for managing the bus 702 and general processing, including the execution of software stored on the computer-readable medium 706. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 704, causes the processing system 714 to perform the various functions described below for any particular apparatus. The computer-readable medium 706 and the memory 705 also may be used for storing data that is manipulated by the processor 704 when executing software.

The computer-readable medium 706 may be a non-transitory computer-readable medium. A non-transitory computer-readable medium includes, by way of example, a magnetic storage device (such as hard disk, floppy disk, magnetic strip), an optical disk (such as a compact disc (CD) or a digital versatile disc (DVD)), a smart card, a flash memory device (such as a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. In some examples, the computer-readable medium 706 may be part of the memory 705. Those skilled in the art will recognize how best to implement the described functionality presented throughout this disclosure depending on the particular application and the overall design constraints imposed on the overall system.

In some aspects of the disclosure, the processor 704 may include circuitry configured for various functions. For example, the processor 704 may include resource assignment and scheduling circuitry 742 configured to assign resources and scheduling for signaling radio bearers (SRBs) and data radio bearers (DRBs) with UEs. The resource assignment and scheduling circuitry 742 may further be configured to execute resource assignment and scheduling software 752 stored in the computer-readable medium 706 to implement one or more of the functions described herein.

The processor 704 further includes DL traffic and control generation and transmission circuitry 744 for transmitting DL signaling and data to UEs. For example, with regard to wireless communication system 300, the DL traffic and control generation and transmission circuitry 744 of base station 320 or 330 would control the transmission of DL signaling and data to the UE 310 via one or more SRBs 312 or 316 and one or more DRBs 314 or 318. The DL traffic and control channel and transmission circuitry 744 may further be configured to execute DL traffic and control channel reception and processing software 754 stored in the computer-readable medium 706 to implement one or more of the functions described herein.

The processor 704 may further include uplink (UL) traffic and control channel reception and processing circuitry 746, configured to receive and process uplink control channels and uplink traffic channels from one or more UEs. For example, the UL traffic and control channel reception and processing circuitry 746 may be configured to receive uplink control information (UCI) or uplink user data traffic from one or more UEs via one or more SRBs 312 or 316 and one or more DRBs 314 or 318. The UL traffic and control channel reception and processing circuitry 746 may further be configured to execute UL traffic and control channel reception and processing software 756 stored in the computer-readable medium 706 to implement one or more of the functions described herein.

The processor 704 may further include backhaul signaling management circuitry 748 configured to perform backhaul signaling management 748 for a base station. For example, the backhaul signaling management circuitry 748 may be configured to transmit information regarding one or more CQI measurements for the master base station 320 to the secondary base station 330 via backhaul communication link 322. The backhaul signaling management circuitry 748 may further be configured to execute backhaul signaling management software 758 stored in the computer-readable medium 706 to implement one or more of the functions described herein.

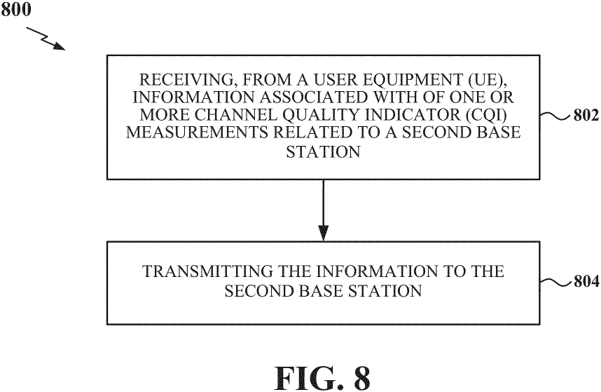

FIG. 8 shows an example flowchart of a method 800 for reporting, by a master base station to a secondary base station, information regarding channel quality indicator (CQI) measurements performed by a user equipment (UE) based on reference signals received from the secondary base station for link adaptation purposes. The method 800 includes the processor 704 receiving, from a user equipment (UE), information associated with one or more channel quality indicator (CQI) measurements related to a second base station via the wireless transceiver 710 (block 802). The method 800 further includes the processor 704 transmitting the information to a second base station via the backhaul link interface 711 (block 804).

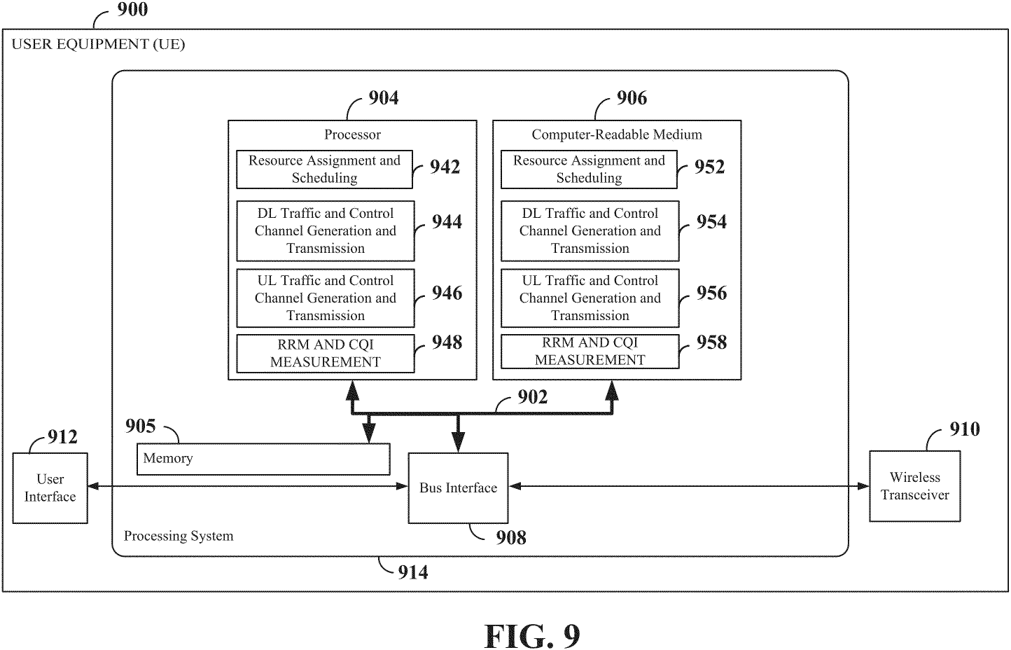

FIG. 9 shows a block diagram of an example hardware implementation of a user equipment (UE) 900. The UE 900 is depicted employing a processing system 914. For example, the UE 900 may correspond to any of the UEs previously discussed herein, such as UE 310.

The UE 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 900 may be configured to perform any one or more of the functions described herein. That is, the processor 904, as utilized in the UE 900, may be used to implement any one or more of the processes and procedures described below.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (represented generally by the processor 904), a memory 905, and computer-readable media (represented generally by the computer-readable medium 906). The bus 902 also may link various other circuits such as timing sources, peripherals, voltage regulators, and power management circuits, which are well known in the art, and therefore, will not be described any further.

A bus interface 908 provides an interface between the bus 902 and a wireless transceiver 910. The wireless transceiver 910 allows for the UE 900 to communicate with various other apparatus over a transmission medium (such as air interface). Depending upon the nature of the apparatus, a user interface 912 (such as keypad, display, touch screen, speaker, microphone, control knobs, etc.) also may be provided. Of course, such a user interface 912 is optional, and may be omitted in some examples.

The processor 904 is responsible for managing the bus 902 and general processing, including the execution of software stored on the computer-readable medium 906. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 904, causes the processing system 914 to perform the various functions described below for any particular apparatus. The computer-readable medium 906 and the memory 905 also may be used for storing data that is manipulated by the processor 904 when executing software.

The computer-readable medium 906 may be a non-transitory computer-readable medium. A non-transitory computer-readable medium includes, by way of example, a magnetic storage device (such as hard disk, floppy disk, magnetic strip), an optical disk (such as a compact disc (CD) or a digital versatile disc (DVD)), a smart card, a flash memory device (such as a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. In some examples, the computer-readable medium 906 may be part of the memory 905. Those skilled in the art will recognize how best to implement the described functionality presented throughout this disclosure depending on the particular application and the overall design constraints imposed on the overall system.

In some aspects of the disclosure, the processor 904 may include circuitry configured for various functions. For example, the processor 904 may include resource assignment and scheduling circuitry 942 configured to assign resources and scheduling for signaling radio bearers (SRBs) and data radio bearers (DRBs) with base stations. The resource assignment and scheduling circuitry 942 may further be configured to execute resource assignment and scheduling software 952 stored in the computer-readable medium 906 to implement one or more of the functions described herein.

The processor 904 further includes DL traffic and control generation and transmission circuitry 944 for receiving DL signaling and data from base stations. For example, with regard to wireless communication system 300, the DL traffic and control generation and transmission circuitry 944 of UE 310 would control the reception of DL signaling and data from the master base station 320 via one or more SRBs 312 or 316 and from the secondary base station 330 via one or more DRBs 314 or 318. The DL traffic and control channel and transmission circuitry 944 may further be configured to execute DL traffic and control channel reception and processing software 954 stored in the computer-readable medium 906 to implement one or more of the functions described herein.

The processor 904 may further include uplink (UL) traffic and control channel reception and processing circuitry 946, configured to process and transmit uplink control channel signaling and uplink traffic data to one or more base stations. For example, the UL traffic and control channel reception and processing circuitry 946 may be configured to transmit uplink control information (UCI) or uplink user data traffic to the master base station 320 via one or more SRBs 312 or 316 and to the secondary base station 330 via one or more DRBs 314 or 318. The UL traffic and control channel reception and processing circuitry 946 may further be configured to execute UL traffic and control channel reception and processing software 956 stored in the computer-readable medium 906 to implement one or more of the functions described herein.

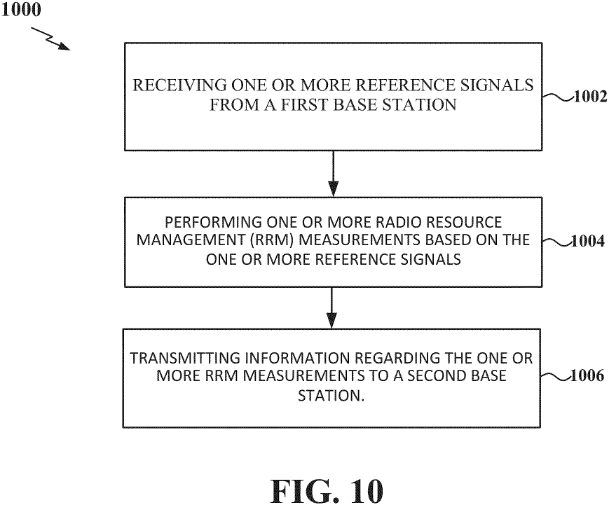

FIG. 10 shows an example flowchart of a method 1000 of reporting, by a user equipment (UE) to a master base station, radio resource management (RRM) measurements performed by the UE based on reference signals received from a secondary base station. The method 1000 includes the processor 904 receiving one or more reference signals from a first base station via the wireless transceiver 910 (block 1002). The method 1000 further includes the processor 904 performing one or more radio resource management (RRM) measurements based on the one or more reference signals (block 1004). The method 1000 further includes the processor 904 transmitting information regarding the one or more RRM measurements to a second base station via the wireless transceiver 910 (block 1006).

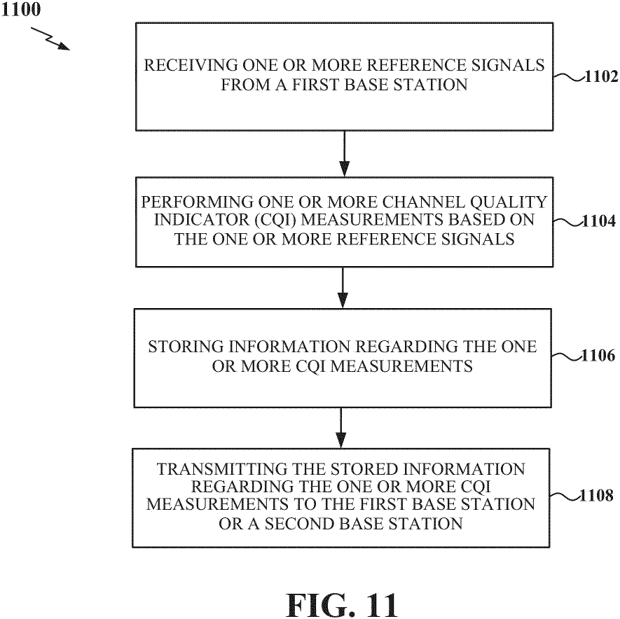

FIG. 11 shows an example flowchart of a method 1100 of reporting, by a user equipment (UE) to a master base station, radio resource management (RRM) measurements performed by the UE based on reference signals received from a secondary base station. The method 1100 includes the processor 904 receiving one or more reference signals from a first base station via the wireless transceiver 910 (block 1102). The method 1100 further includes the processor 904 performing one or more channel quality indicator (CQI) measurements based on the one or more reference signals (block 1104). The method 1100 further includes the processor 904 storing information regarding the one or more CQI measurements in the memory 905 (block 1106). The method 1100 further includes the processor 904 transmitting the stored information regarding the one or more CQI measurements to the first base station or a second base station via the wireless transceiver 910 (block 1108).

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3 GPP. such as Long-Term Evolution (LTE), the Evolved Packet System (EPS), the Universal Mobile Telecommunication System (UMTS), or the Global System for Mobile (GSM). Various aspects also may be extended to systems defined by the 3rd Generation Partnership Project 2 (3 GPP2), such as CDMA2000 or Evolution-Data Optimized (EV-DO). Other examples may be implemented within systems employing IEEE 802.11 (Wi-Fi), IEEE 802.16 (WiMAX). IEEE 802.20. Ultra-Wideband (UWB), Bluetooth, or other suitable systems. The actual telecommunication standard, network architecture, or communication standard employed will depend on the specific application and the overall design constraints imposed on the system.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “tower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method for wireless communication at an apparatus of a user equipment (UE), comprising:
receiving one or more reference signals from a first base station;
performing one or more radio resource management (RRM) measurements based on the one or more reference signals; and
transmitting information regarding the one or more RRM measurements to a second base station.

2. The method of claim 1, wherein performing the one or more RRM measurements is based on a configuration for the one or more RRM measurements received from the first base station.

3. The method of claim 1, wherein the UE is in a dormant or deactivated operating state associated with a secondary cell group (SCG) of the first base station during the receiving of the one or more reference signals, the performing of the one or more RRM measurements, and the transmitting of the information.

4. The method of claim 3, wherein there is no data transmission occurring between the UE and the first base station while the UE is in the dormant or deactivated operating state.

5. The method of claim 3, wherein the UE is not monitoring a physical downlink control channel (PDCCH) signal transmitted by the first base station while the UE is in the dormant or deactivated operating state.

6. The method of claim 3, wherein the UE is not performing channel quality indicator (CQI) measurements associated with the first base station while the UE is in the deactivated operating state.

7. The method of claim 3, further comprising performing one or more channel quality indicator (CQI) measurements associated with the first base station and transmitting information of the one or more CQI measurements to the first or second base station while the UE is in the dormant operating state.

8. The method of claim 1, wherein transmitting the information regarding the one or more RRM measurements to the second base station occurs via a signaling radio bearer (SRB).

9. The method of claim 1, wherein transmitting the information regarding the one or more RRM measurements to the second base station occurs via a signaling radio bearer 1 (SRB1) as defined in a Long-Term Evolution (LTE) or New Radio (NR) specifications.

10. The method of claim 1, wherein transmitting the information regarding the one or more RRM measurements to the second base station occurs via a first signaling radio bearer (SRB) while a second SRB exists for transmitting signaling from the UE to the first base station.

11. The method of claim 1, wherein the transmitting information regarding the one or more RRM measurements to the second base station occurs via a signaling radio bearer 1 (SRB1) while a SRB3 exists for transmitting signaling from the UE to the first base station, wherein the SRB1 and the SRB3 are defined in LTE or NR specifications.

12. The method of claim 1, wherein the second base station is a master base station and the first base station is a secondary base station in a multiple-radio access technology (RAT) dual connectivity configuration.

13. The method of claim 1, wherein the first base station includes a set of cells, wherein receiving the one or more reference signals from the first base station comprises receiving a set of the reference signals from the set of cells, respectively, wherein performing the one or more RRM measurements comprises performing a set of RRM measurements based on the set of reference signals based on a configuration for the set of RRM measurements received from the first base station, and wherein transmitting the information regarding the one or more RRM measurements to the second base station comprises transmitting information regarding the set of RRM measurements to the second base station.

14. A user equipment, comprising:
a wireless transceiver; and
a processor configured to:
receive one or more reference signals from a first base station via the wireless transceiver;
perform one or more radio resource management (RRM) measurements based on the one or more reference signals; and
transmit information regarding the one or more RRM measurements to a second base station via the wireless transceiver.

15. The user equipment of claim 14, wherein the processor is configured to perform the one or more RRM measurements based on a configuration for the one or more RRM measurements received from the first base station.

16-58. (canceled)

59. A method for wireless communication at an apparatus of a first base station, the method comprising:
receiving, from a user equipment (UE), information associated with one or more channel quality indicator (CQI) measurements related to a second base station; and
transmitting the information to the second base station.

60. The method of claim 59, wherein receiving the information occurs while the UE is in a dormant state.

61. The method of claim 59, wherein transmitting the information to the second base station occurs via a backhaul communication link.

62. The method of claim 59, wherein transmitting the information to the second base station occurs via an Xn/X2 link as defined in LTE or NR specifications.

63. The method of claim 59, wherein receiving the information from the UE occurs via a signaling radio bearer (SRB).

64. The method of claim 59, wherein receiving the information from the UE occurs via a signaling radio bearer 1 (SRB1) as defined by in LTE or NR.

65. The method of claim 59, wherein receiving the information from the UE comprises receiving the information via a physical uplink control channel (PUCCH).

66. The method of claim 59, wherein receiving the information from the UE comprises receiving the information via a physical uplink shared channel (PUSCH).

67. The method of claim 59, wherein the first base station is a master base station and the second base station is a secondary base station in a multiple RAT dual connectivity configuration.

68. The method of claim 59, wherein the information of the one or more channel quality indicator (CQI) measurements comprises a set of CQI measurements related to a set of cells supported by the second base station, respectively.

69. A base station, comprising:
a wireless transceiver;
a backhaul interface; and
a processor configured to:
receive, from a user equipment (UE) via the wireless transceiver, information associated with one or more channel quality indicator (CQI) measurements related to another base station; and
transmit the information to the second base station via the backhaul interface.

70. The base station of claim 69, wherein the processor is configured to receive the information from the user equipment via a signaling radio bearer (SRB).

71. The base station of claim 69, wherein the processor is configured to receive the information from the user equipment via a signaling radio bearer 1 (SRB1) as defined by in LTE or NR.

72. The base station of claim 69, wherein the processor is configured to receive the information from the user equipment via a physical uplink control channel (PUCCH).

73. The base station of claim 69, wherein the processor is configured to receive the information from the UE via a physical uplink shared channel (PUSCH).

74-76. (canceled)
